(19) United States
(12) Patent Application Publication
(10) Pub. No.: US 2009/0087727 A1
(43) Pub. Date: Apr. 2, 2009

(54) BATTERY PACK

(75) Inventors: Yasuhiro HARADA, Yokohama-shi (JP); Norio Takami, Yokohama-shi (JP); Hiroki Inagaki, Kawaski-shi (JP); Yoshinao Tatebayashi, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 12/328,178

(22) Filed: Dec. 4, 2008

Related U.S. Application Data
(63) Continuation of application No. PCT/JP08/64071, filed on Jul. 30, 2008.

(30) Foreign Application Priority Data
Aug. 23, 2007 (JP) 2007-216998

(51) Int. Cl. H01M 10/50

(52) U.S. Cl. 429/120

(57) ABSTRACT

There is disclosed a battery pack which comprises a packing case, a combination battery housed in the packing case and having a plurality of flat and rectangular type secondary batteries which are laminated each other, a hollow body interposed at least between the flat and rectangular type secondary batteries in the combination battery and made of a thermoplastic resin film having a melting point of 110 to 200° C., and a cooling medium passed through the hollow body and includes an nonflammable insulating solvent.

### CROSS REFERENCE TO RELATED APPLICATIONS

This is a Continuation Application of PCT Application No. PCT/JP2008/064071, filed Jul. 30, 2008, which was published under PCT Article 21(2) in English.

This application is based upon and claims the benefit of priority from prior Japanese Patent Application No. 2007-216998, filed Aug. 23, 2007, the entire contents of which are incorporated herein by reference.

### BACKGROUND OF THE INVENTION

1. Field of the Invention

This invention relates to a battery pack, in particular, to a battery pack provided with a cooling function.

2. Description of the Related Art

In recent years, due to the enhancement in performance of a secondary battery, the application of the secondary battery is extended from mobile electronic instruments to various fields such as hybrid cars, electric cars, power sources for power storage, etc. In view of these backgrounds, the secondary battery is now demanded to exhibit not only high input/output performance and high energy density but also prolong life and excellent operability at a wide range of temperatures. Further, concomitant with increasing demands for a higher output power source, there is also an urgent problem with regard to the technological development of a combination battery wherein a large number of secondary batteries (or cells) are laminated with each other.

As for specific examples of the secondary battery to be used in various fields, there are known a nickel hydrogen secondary battery and lithium ion secondary battery. Since these secondary batteries are excellent in rapid charge/discharge performance and advantageous in high energy density, they are widely employed for various applications including mobile electronic instruments and electric power storage.

Conventionally, the outer case for the secondary battery is modified from a columnar shape to a flat and rectangular shape in an attempt to enhance the energy density of the combination battery. This flat and rectangular type secondary battery is effective in making it possible, on the occasion of forming a combination battery, to minimize gaps between adjacent secondary batteries and hence to minimize dead space in the combination battery. However, the combination battery which is constituted by a lamination of a large number of flat and rectangular type secondary batteries is more or less accompanied with problems in terms of temperature equalization of all secondary batteries and heat dissipation thereof. Especially when such a combination battery is applied to a high-output secondary battery which is designed to deliver a large current, a large magnitude of heat would be produced on the occasion of rapid charging/discharging. In the case of the combination battery where the flat and rectangular type secondary batteries are laminated as described above, the cooling and temperature equalization of each secondary battery are now becoming important issues in improving the life of battery or retaining the capacity of battery.

More specifically, in the case of the combination battery comprising a plurality of columnar secondary batteries, a gap is inevitably produced between adjacent batteries. Therefore, it is relatively easy to perform the thermal management of all secondary batteries such as the temperature equalization, heat dissipation and thermal insulation of all secondary batteries by simply passing mainly air as a thermal transfer medium through the gap. Whereas, in the case of the combination battery comprising a plurality of flat and rectangular type secondary batteries, there is substantially no gap is between adjacent batteries. Therefore, even if a thermal transfer medium is introduced into such a combination battery, thermal non-uniformity is liable to occur within the combination battery.

To overcome this problem, there has been proposed a technique wherein a space is provided between adjacent flat and rectangular type secondary batteries and a cooling medium (for example, air) is passed through the space to thereby cool the secondary batteries. However, in the case of this technique, since the gap between the batteries is utilized as a flow channel, a differential pressure is produced in the combination battery depending on the positional relationship between the arrangement of the batteries and the position of the cooling fan, thereby more likely producing a non-uniform flow distribution within the combination battery.

JP-A 2006-184272 (KOKAI) discloses a flat and rectangular type secondary battery wherein a flow channel is provided at the gaps between the secondary batteries and water is used as a cooling medium. However, the use of water as a cooling medium for cooling a large scale non-aqueous solvent type secondary battery is not preferable. Especially, in the case of a lithium ion secondary battery containing a substance which is prohibited the use of water, there are much possibilities of causing overheating/ignition of battery by the reaction of the substance with water. Additionally, there is a problem which is peculiar to the lithium ion battery that since the reactivity of lithium used as an active material is high in reactivity and an organic electrolyte is used, there is great likelihood of causing a short circuit and abnormal heat build-up in the battery.

Furthermore, in the case of the battery where a large electric power is required as in the case of hybrid cars and electric motor cars, since a large current is required to be delivered by the battery, the battery temperature may be caused to rise instantaneously if a short circuit occurs in the battery. In the case of a large scale combination battery where a plurality of the aforementioned secondary batteries are laminated, the employment of air containing oxygen or the employment of water which is highly reactive with lithium as a cooling medium may raise a problem in viewpoint of safety as described above.

JP-A 9-259940 (KOKAI) discloses a technique of preventing the ignition of battery wherein a cooling flow channel constituted by a combination of a hot-melt film and a porous material is provided on the outer circumferential surface of the outer case housing a combination battery consisting of a lamination of a plurality of secondary batteries. In this case, the porous film is caused to melt as the battery is abnormally heated, thereby allowing the cooling medium to flow into the interior of outer case to prevent the ignition of battery. However, this technique is accompanied with a problem that unless the abnormal heat build-up of secondary batteries constituting the combination battery is transmitted to the outer circumferential surface of the outer case, the safety mechanism thereof would not be actuated. For example, when the abnormal heat build-up occurs in a secondary battery which is disposed at a central portion of the combination battery, a fairly long time would be required for this abnormal heat build-up to reach the outer circumferential surface of the outer case. In the case of the combination battery constituted by a lamination of a large number of secondary batteries each having a large capacity, when abnormal heat build-up occurs in one of the secondary batteries for some reason, other normal secondary batteries adjacent to the heated secondary battery may be also heated, possibly resulting in induced over-heating/ignition of a battery. For this reason, it is required to immediately detect the heat build-up in the secondary battery and to cope with the heat build-up.

Meanwhile, the vibration resistance of combination battery is also an important theme in viewpoint of the reliability of combination battery. Especially in the case of secondary battery to be used as a power source for hybrid cars and electric motor cars which have been vigorously studied and developed in recent years, high vibration resistance and high collisional safety of battery are noticed as important.

### BRIEF SUMMARY OF THE INVENTION

According to the present invention, there is provided a battery pack, comprising:

a packing case;

a combination battery housed in the packing case and having a plurality of flat and rectangular type secondary batteries which are laminated each other;

a hollow body interposed at least between the flat and rectangular type secondary batteries in the combination battery and made of a thermoplastic resin film having a melting point of 110 to 200° C.; and

a cooling medium passed through the hollow body and comprising an nonflammable insulating solvent.

### BRIEF DESCRIPTION OF THE SEVERAL VIEWS OF THE DRAWING

FIG. 1 is a perspective view illustrating a battery pack according to one embodiment of the present invention;

FIG. 2 is a partially cut perspective view illustrating one of the flat and rectangular type batteries constituting a combination battery of the battery pack shown in FIG. 1;

FIG. 3 is an enlarged cross-sectional view illustrating the portion “A” of FIG. 2;

FIG. 4 is a perspective view illustrating a battery pack according to another embodiment of the present invention;

FIG. 5 is a graph illustrating the changes with time of temperature of five flat and rectangular type secondary batteries constituting the combination battery according to Example 1; and

FIG. 6 is a graph illustrating the changes with time of temperature of five flat and rectangular type secondary batteries constituting the combination battery according to Comparative Example 1.

### DETAILED DESCRIPTION OF THE INVENTION

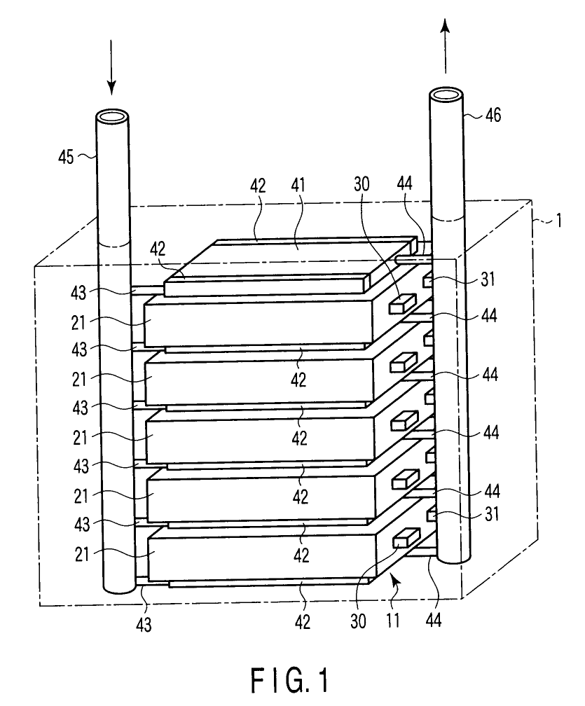

Next, a battery pack according to one embodiment of the present invention will be explained with reference to FIGS. 1 to 3.

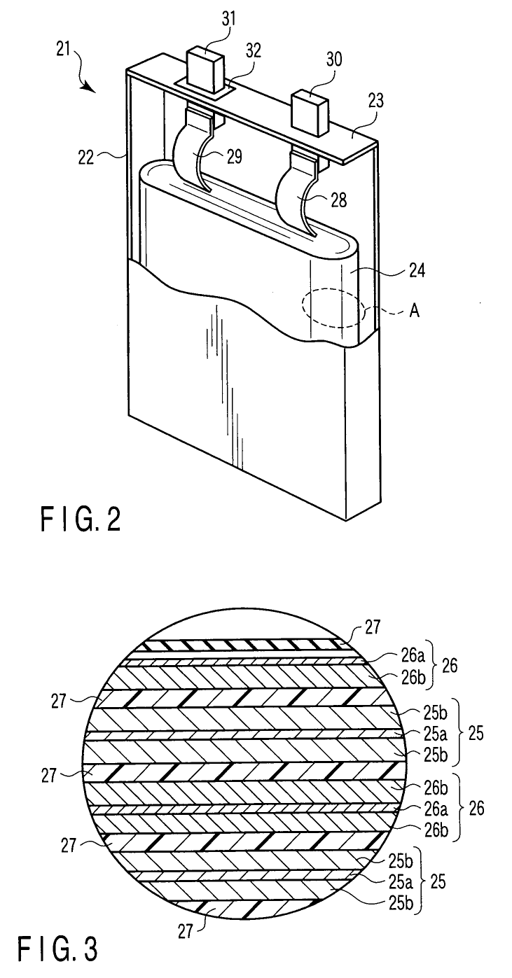

FIG. 1 is a perspective view illustrating a battery pack according to one embodiment. FIG. 2 is a partially cut perspective view illustrating a flat and rectangular type battery. FIG. 3 is an enlarged cross-sectional view illustrating the portion “A” of FIG. 2. A combination battery 11 is accommodated in a pack case 1 which can be hermetically closed. This combination battery 11 has a plurality of flat and rectangular type secondary batteries (for example, flat and rectangular type lithium ion secondary batteries) 21 which are laminated each other and electrically connected in series for instance. By the way, this plurality of flat and rectangular type batteries may be connected in parallel with each other or connected through a combination of series connection and parallel connection.

As shown in FIGS. 2 and 3 for example, the flat and rectangular type secondary battery 21 comprises a rectangular cylindrical metal can 22 with a bottom, and a square flat lid 23 bonded airtightly to an upper end opening of the metal can 22 by, for example, laser welding. A flattened wound electrode group 24 is accommodated in the cylindrical metal can 22. As shown in FIG. 3, the electrode group 24 is constructed such that a laminate comprising a positive electrode 25, a negative electrode 25 and a separator 27 which is interposed between the positive electrode 25 and the negative electrode 25 is spirally wound and press-molded to form the electrode group 24. In this electrode group 24, the outermost husk is position with the separator 27. The positive electrode 25 comprises a current collector 25a and an active material-containing layer 25b which is formed on the both surfaces of the current collector 25a. A positive electrode lead tab 28 is integrally connected with the current collector 25a of the positive electrode 25. The negative electrode 26 comprises a current collector 26a and an active material-containing layer 26b which is formed on the both surfaces of the current collector 26a. A negative electrode lead tab 29 is integrally connected with the current collector 26a of the negative electrode 26.

A non-aqueous electrolyte is contained in the metal can 22 in which the electrode group 24 is located. A positive electrode terminal 30 having a plate-like configuration for example is pierced through the lid 23. The positive electrode lead tab 28A is electrically connected with an end portion of the positive electrode terminal 30 which is located inside the metal can 22. A negative electrode terminal 31 having a plate-like configuration for example is pierced through the lid 23 and hermetically sealed to the lid 23 by making use of a glass material 32. The negative electrode lead tab 29A is electrically connected with an end portion of the negative electrode terminal 31 which is located inside the metal can 22.

A flat hollow body (bag) 41 is disposed between the flat and rectangular type secondary batteries 21 of the combination battery 11 and on the outermost surfaces (intersecting with the direction of lamination) of the combination battery 11 (i.e., on the top surface of the uppermost flat and rectangular type secondary battery 21 of the combination battery 11 and on the bottom surface of the lowermost flat and rectangular type secondary battery 21 of the combination battery 11). The flat hollow body 41 is made of a thermoplastic resin film having a melting point of 110 to 200° C. A couple of plate-like spacers 42 are interposed between the flat and rectangular type secondary battery 21 in such a manner that they are disposed to respectively contact with the opposite sides of the hollow body 41, thereby disposing them in parallel with each other and along the longitudinal direction of the flat and rectangular type secondary battery 21. A couple of plate-like spacers 42 are also disposed so as to respectively contact with the opposite sides of the hollow body 41 which is disposed on the top surface of the uppermost flat and rectangular type secondary battery 21 of the combination battery 11 and with the opposite sides of the hollow body 41 which is disposed on the bottom surface of the lowermost flat and rectangular type secondary battery 21 of the combination battery 11, thereby disposing them in parallel with each other and along the longitudinal direction of the flat and rectangular type secondary battery 21. Each of the spacers is made of, for example, synthetic resin or rubber. The combination battery 11 with the hollow bodies 41 being respectively interposed between the secondary batteries is clamped by means of a band (not shown). Alternatively, the spacer may be formed into a frame-like configuration so as to enable it to contact with all of the outer circumferential sidewalls of the hollow body 41.

Each of the hollow bodies 41 is provided with an inlet side joint tube 43 and with an outlet side joint tube 44. More specifically, the inlet side joint tube 43 is attached to the sidewall of the hollow body 41 which is opposite in location to the projecting sidewall of the positive and negative electrodes 30 and 31 of the flat and rectangular type secondary battery 21. Whereas, the outlet side joint tube 44 is attached to the sidewall of the hollow body 41 which is the same in location to the projecting sidewall of the positive and negative electrodes 30 and 31. A supply side cooling pipe 45 for supplying a cooling medium formed of a noncombustible insulating solvent is inserted into the pack case 1 and along the laminating direction of the combination battery 11, enabling the supply side cooling pipe 45 to communicate with all of the inlet side joint tubes 43. A discharge side cooling pipe 46 for discharging the cooling medium is inserted into the pack case 1 and along the laminating direction of the combination battery 11, enabling the discharge side cooling pipe 46 to communicate with all of the outlet side joint tubes 44. Thus, the cooling medium formed of a noncombustible insulating solvent and supplied to the supply side cooling pipe 45 is permitted to flow, via each of the inlet side joint tubes 43, into each of the hollow bodies 42, thereby cooling each of the flat and rectangular type secondary batteries 21 of the combination battery 11, which are contacted with the hollow bodies 42. Then, the cooling medium is discharged, via the outlet side joint tubes 44 which are located opposite to the inlet side joint tubes 43, from the discharge side cooling pipe 46.

In a preferable embodiment, the aperture diameter of the inlet side joint tube 43 may be made larger than the aperture diameter of the outlet side joint tube 44. For example, it may be preferable to make the aperture diameter of the inlet side joint tube 43 1.1 to 2.0 times as large as the aperture diameter of the outlet side joint tube 44. When the aperture diameter of the inlet side joint tube 43 is made larger than the aperture diameter of the outlet side joint tube 44, a differential pressure can be produced between the inlet and outlet ports of the hollow body 41 as the cooling medium is supplied to the interior of the hollow body 41 through the inlet side joint tube 43, thereby making it possible to sufficiently expand the volume of the hollow body 41 by making use of the cooling medium. Namely, when the hollow body 41 interposed between the flat and rectangular type secondary batteries 21 is sufficiently expanded in volume and most of the opposite surfaces of the hollow body 41 are enabled to contact the surface of flat and rectangular type secondary battery 21, the flat and rectangular type secondary battery 21 can be uniformly and effectively cooled. Incidentally, since the spacer 42 is disposed on the opposite sidewalls of the hollow body 41, the expansion of the hollow body 41 in the horizontal direction can be regulated during the in-flow of the cooling medium into the hollow body 41 in a manner to produce a differential pressure. For this reason, it is possible to interpose the hollow body 41 having an approximately rectangular configuration.

The pack case 1 can be manufactured by making use of, for example, aluminum, copper, stainless steel, and light alloy metals.

The thermoplastic resin having a melting point ranging from 110 to 200° C. and constituting the raw material of the hollow body can be used olefin-based heat fusible resin such as polyethylene and polypropylene; ester-based heat fusible resin such as polyester, oxybenzoyl polyester and polybutylene terephthalate; and urethane-based heat fusible resin such as polyester urethane and polyurethane. This hollow body may be fabricated from a single thermoplastic resin film or a laminate film consisting of a plurality of thermoplastic resin films.

The thickness of the thermoplastic resin film should preferably be confined within the range of 100 to 300 μm in view of securing the strength, fusibility and breakage resistance of the hollow body to be fabricated.

The nonflammable insulating solvent to be employed as a cooling medium can be used, for example, as diisopropyl naphthalene, 1-phenyl-1-(3,4-dimethylphenyl)ethane, liquid cellulose, ethylene glycol, carbon tetrachloride.

According to the battery pack constructed as described above, a cooling medium comprising an nonflammable insulating solvent and fed to the supply side cooling pipe 45 is permitted to flow, via each of the inlet side joint tubes 43, into each of the hollow bodies 42. Thereafter, the cooling medium is discharged, via the outlet side joint tubes 44, from the discharge side cooling pipe 46. On this occasion, the top and bottom surfaces of each of the flat and rectangular type secondary batteries 21 constituting the combination battery 11 are enabled to contact with the bottom and top surfaces (i.e., the surfaces extending along the flowing direction of the cooling medium) of each of the hollow bodies 42. As a result, each secondary battery 21 can be cooled due to the passing of the cooling medium through each of the hollow bodies 41, thereby making it possible to equalize the temperature of each secondary battery 21 without giving rise to the localization of temperature in the in-plane temperature distribution. Further, with respect to the temperature distribution among the secondary batteries 21 constituting the combination battery 11, it is also possible to equalize the temperature of all of the secondary batteries 21 without giving rise to the temperature distribution effect wherein the temperature of the secondary battery 21 located closer to the central portion of the combination battery 11 becomes higher in temperature.

Additionally, the combination battery 11 comprises a plurality of the flat and rectangular type secondary batteries 21, and the hollow body 41 which is interposed between the secondary batteries 21, the hollow body 41 being made of a thermoplastic resin film and filled with a cooling medium. Therefore, the hollow body 41 is enabled to act as a cushioning material relative to the secondary batteries 21. As a result, it is now possible to prevent the secondary batteries 21 from being rubbed against each other, thus making it possible to obtain a battery pack equipped with a combination battery 11 which is excellent in vibration resistance and in shock resistance. Especially, since a couple of spacers are positioned respectively on the opposite sides of each of the hollow bodies 41, the application of load by the secondary battery 21 to the hollow body 41 can be alleviated and hence the strength of the hollow body 41 itself can be retained.

Meanwhile, since the hollow body 41 through which a cooling medium is enabled to pass, is formed of a thermoplastic resin film having a melting point ranging from 110 to 200° C., once abnormal heat build-up or ignition of the secondary battery 21 constituting the combination battery 11 is produced, the hollow body 41 which is in contact with the secondary battery 21 affected by the abnormal heat build-up or ignition melts or is damaged. In this case, the cooling medium passing through the hollow body 41 is permitted to flow out of the hollow body 41 through this damaged portion and to enter into the interior of the pack case 1, thus filling the pack case 1 with the cooling medium. Since the cooling medium filling the interior of the pack case 1 comprises an nonflammable insulating solvent, the in-flow of oxygen or water of the outer atmosphere can be intercepted by this cooling medium, thereby making it possible to prevent the spreading of ignition. Further, in a situation where the abnormal heat build-up or ignition occurs in one of the secondary batteries 21, the employment of the nonflammable insulating solvent is effective in overcoming the problem of safety that may result from the employment of the conventional cooling medium, i.e., the employment of air containing oxygen or the employment of water which is highly reactive with lithium.

Accordingly, it is now possible to provide a highly safe battery pack which is excellent in cooling performance, vibration resistance and shock resistance and capable of suppressing or preventing the spreading of ignition that may be caused by the abnormal heat build-up or ignition in one of the flat and rectangular type secondary batteries 21.

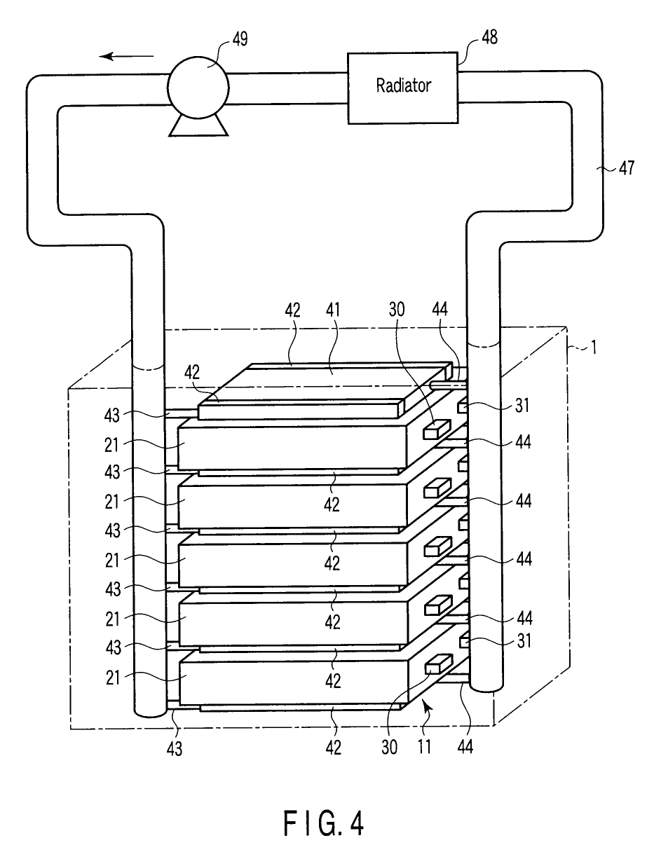

In another embodiment, there is proposed a modified structure as shown in FIG. 4. One end portion of a cooling pipe 47 is communicated with the inlet side joint tubes 43 and the other end portion of a cooling pipe 47 being communicated with the outlet side joint tubes 44. A radiator 48 and a pump 49 are further provided on an intermediate portion of this cooling pipe 47 as mentioning from the outlet side joint tubes 44 side, thereby forming a circulating flow path. According to this embodiment shown in FIG. 4, the cooling medium introduced into each of the hollow bodies 41 of the combination battery 11 is permitted to flow, through each of the outlet side joint tubes 44, into the cooling pipe 47 and then to pass through the radiator 48, thereby cooling the cooling medium. Then, the cooling medium thus cooled is moved by means the pump 49 to flow, via each of the inlet side joint tubes 43, into each of the hollow bodies 41, thereby performing the circulation of the cooling medium. The aperture diameter of the inlet side joint tube 43 should preferably be 1.1 to 2.0 times as large as the aperture diameter of the outlet side joint tube 44. Incidentally, a heat exchanger may be used in place of the radiator.

Next, the constituent components of a flat and rectangular type secondary battery (for example, a lithium ion secondary battery having a flat and rectangular type configuration) constituting the battery pack will be explained in detail.

1) Negative Electrode

The negative electrode comprises a current collector, and an active material-containing layer which is formed on one or both surfaces of the current collector and contains an active material of negative electrode, a conductive agent and a binder.

The active material of negative electrode may be made of a carbonaceous material or titanium-containing metal composite oxide which is capable of absorbing and desorbing lithium for example. Especially, it is preferable to use a material whose electric potential to metal lithium is higher than 0.5V, e.g. titanium-containing metal composite oxide such as lithium titanate, since such a material is capable of preventing the deposition of lithium dendrite on the negative electrode and also capable of minimizing the degradation of negative electrode even if the battery is rapidly charged.

The titanium-containing metal composite oxide can be used, for example, as titanium-based oxide, lithium titanium oxide, and lithium titanium composite oxide that can be obtained by substituting a different kind of element for part of the constituent elements of lithium titanium oxide. The lithium titanium oxide can be used lithium titanate having a spinel structure (for example, Li₄₊ₓTi₅O₁₂ [wherein x is a value that can be changed depending on charging/discharging and confined to the range of: 0≦x≦3]), and Ramsdellite-type lithium titanate (for example, Li_{2+y}Ti₃O₇ [wherein y is a value that can be changed depending on charging/discharging and confined to the range of: 0≦y≦3]). By the way, as for the mole percentage of oxygen, although 12 is formally given to the spinel-type Li₄₊ₓTi₅O₁₂ and 7 to the Rhamsdellite-type Li_{2+y}Ti₃O₇, these values can be changed depending on the influence by oxygen nonstoichiometry, etc. The titanium-based oxide can be used TiO₂ and metal composite oxide containing Ti and at least one kind of element selected from the group consisting of P, V, Sn, Cu, Ni, Co and Fe. TiO₂ is preferably selected from those of anatase-type and of low crystallinity, so that the thermal management thereof can be performed at a temperature ranging from 300° C. to 500° C. The metal composite oxide containing Ti and at least one element selected from the group consisting of P, V, Sn, Cu, Ni, Co and Fe include, for example, TiO₂—P₂O₅, TiO₂—V₂O₅, TiO₂—P₂O₅—SnO₂, TiO₂—P₂O₅-MeO (wherein Me is at least one kind of element selected from the group consisting of Cu, Ni, Co and Fe), etc. This metal composite oxide should preferably be selected from those having a micro-structure wherein a crystal phase and an amorphous phase are co-existed or wherein only an amorphous phase is existed. With the employment of the metal composite oxide having aforementioned micro-structure, the charge/discharge cycle performance of battery can be remarkably enhanced. Among these metal composite oxides, lithium titanium oxide and metal composite oxide containing Ti and at least one element selected from the group consisting of P, V, Sn, Cu, Ni, Co and Fe is especially preferable.

The active material may be also made of a metal sulfide such as lithium sulfide (TiS₂), molybdenum sulfide (MoS₂), iron sulfide (Fe, FeS₂, LiₓFeS₂ (wherein 0<x<4)). The active material may be also made of a metal nitride such as lithium cobalt nitride, e.g. LiₓCo_{y}N (0<x<4, 0<y<0.5).

Lithium titanate can be preferably used as the negative electrode active material. In this case, it is a preferable that the positive electrode active material is lithium cobalt composite oxide, lithium nickel cobalt composite oxide or lithium nickel cobalt manganese composite oxide. In the case of the non-aqueous electrolyte secondary battery comprising such the positive electrode active material and negative electrode active material, the rate of change in voltage “A” relative to the charging depth (state of charge: SOC) in the charging curve on the occasion of charging at 1 C under the environment of 25° C. would become higher than 20 (mV/% SOC) at the moment when the full charge voltage V_{H1} (V) is reached. The non-aqueous electrolyte secondary battery exhibiting the charging curve can be realized even when a carbonaceous material is used as an active material of the negative electrode and lithium manganese composite oxide is used as an active material of the positive electrode.

The active material should preferably be powder (particles) having an average particle diameter of not more than 1 μm. Such active material is effective in enhancing the charge/discharge cycle performance of the non-aqueous electrolyte secondary battery exhibiting the aforementioned charging curve. Especially when rapid charging and high-output discharging of battery are executed, the aforementioned effects would become prominent. However, when this average particle diameter becomes too small, the distribution of the non-aqueous electrolyte would be biased toward the negative electrode side, thereby leading to exhaustion of electrolyte at the positive electrode. For this reason, the lower limit of this average particle diameter should preferably be set to 0.001 μm.

The particle diameter of the active material can be measured by making use of, for example, a laser diffraction distribution-measuring apparatus (SALD-300 [trade name]; Shimazu Seisakusho, Co., Ltd.) and by way of the following procedures. Namely, about 0.1 g of a sample, a surfactant and 1 to 2 mL of distilled water are put in a beaker and then stirred sufficiently to obtain a mixed solution. This mixed solution is then poured into a stirring water tank and the luminous intensity of the mixed solution is measured 64 times with a time interval of two seconds to obtain a data on the particle size distribution. The data thus obtained is subsequently analyzed to measure the particle diameter.

The conductive agent can be used, for example, as carbonaceous materials such as acetylene black, carbon black, carbon fiber, graphite, etc.

Examples of the binder include polytetrafluoroethylene (PTFE), poly(vinylidene fluoride) (PVdF), ethylene-propylene-diene copolymer (EPDM), styrene butadiene rubber (SBR), carboxymethyl cellulose (CMC).

The current collector can be used various kinds of metal foils depending on the electric potential of the negative electrode. The metallic foil is preferable to use, for example, aluminum foil, aluminum alloy foil, stainless steel foil, titanium foil, titanium alloy foil, nickel foil, nickel alloy foil. Preferable the thickness of the metallic foil is 8 to 25 μm. In a case where the electric potential of negative electrode relative to metal lithium is nobler than 0.3V and lithium titanium oxide is used as an active material, the aluminum foil or aluminum alloy foil is preferable due to reduce the weight of battery. By the way, the employment of copper (Cu) is not preferable as copper can be dissolved in a non-aqueous electrolyte, thereby giving adverse influences to the cell reaction.

The aluminum foil or aluminum alloy foil used as the current collector is preferably selected from those having an average crystal grain diameter of not more than 50 μm. The use of the foil of this kind is effective in greatly increasing the mechanical strength of the current collector. Because of this, the negative electrode can be increased in density by making use of high pressing pressure, thereby making it possible to increase the capacity of battery. Additionally, it is possible to prevent the dissolution/corrosive degradation of the current collector on the occasion of over-discharge cycle in a high-temperature environment (at 40° C. or more), thereby making it possible to suppress any rise in impedance at the negative electrode. Furthermore, it is possible to enhance the output characteristics, rapid charging characteristics and charge/discharge cycle characteristics of the battery. More preferably, the average crystal grain diameter of these foils is not more than 30 μm, most preferably not more than 5 μm.

The average crystal grain diameter can be determined according to the following method. Namely, the texture of the surface of the current collector is observed by making use of an optical microscope to determine the number “n” of crystal grains existing in an area of 1 mm×1 mm. Then, by making use of this number “n”, an average crystal grain area “S” is determined according to the equation of:

S=1×10⁶/n (μm²). From the value of S thus obtained, the average crystal grain diameter “d” (μm²) can be determined according to the following equation (1).

D=2(S/π)^{1/2} (1)

The aluminum foil or aluminum alloy foil having an average crystal grain diameter of not more than 50 μm is complicatedly influenced by various factors such as the material composition thereof, impurities, working conditions, heating conditions such as thermal hysteresis and annealing, etc., so that the average crystal grain diameter can be regulated through a combination of these factors during the manufacturing process thereof.

The thickness of aluminum foil or aluminum alloy foil is preferably 20 μm or less, more preferably 15 μm or less. Further, it is desirable that the aluminum foil has a purity of 99% or more. The aluminum alloys may preferably be selected from alloys containing magnesium, zinc, silicon. If aluminum alloys contains a transition metal such as iron, copper, nickel, chromium, the quantity thereof is preferably not more than 1% by weight. By the way, when the lithium ion secondary battery is to be used for mounting it on a vehicle, the use of aluminum alloy foil is especially preferable for fabricating the current collector.

The mixing ratio among the negative electrode active material, the conductive agent and the binder is preferable to confine 80 to 95° by weight of the active material, 3 to 20% by weight of the conductive agent and 1.5 to 7 by weight of the binder.

2) Positive Electrode

The positive electrode comprises a positive electrode current collector, and a positive electrode active material-containing layer which is formed on one or both surfaces of the current collector and contains an active material, a conductive agent and a binder.

The active material can be used various kinds of oxides and sulfides. More specifically, examples of the active material include manganese dioxide (MnO₂), iron oxide, copper oxide, nickel oxide, lithium manganese composite oxides (for example, LiₓMn₂O₄ or LiₓMn₂O₂), lithium nickel composite oxides (for example, LiₓNiO₂), lithium cobalt composite oxides (for example, LiₓCoO₂), lithium nickel cobalt composite oxides (for example, LiNi_{1-y}Co_{y}O₂), lithium manganese cobalt composite oxides (for example, LiₓMn_{y}Co_{1-y}O₂), spinel-type lithium manganese nickel composite oxides (for example, LiₓMn_{2-y}Ni_{y}O₄), lithium phosphorus oxide of olivine structure (for example, LiₓFePO₄, LiₓFe_{1-y}Mn_{y}PO₄, LiₓCoPO₄), iron sulfate (Fe₂(SO₄)₃, vanadium oxide (for example, V₂O₅). Herein x and y are 0<x≦1 and 0<y≦1, respectively. Further, the active material can be also used conductive polymers such as polyaniline and polypyrrole; disulfide-based polymers; or organic or inorganic materials such as sulfur (S), carbon fluoride.

Among the active materials, it is more preferable to use those exhibited higher cell voltage such as lithium manganese composite oxides (LiₓMn₂O₄), lithium nickel composite oxides (LiₓNiO₂), lithium cobalt composite oxides (LiₓCoO₂), lithium nickel cobalt composite oxides (LiNi_{1-y}Co_{y}O₂), spinel-type lithium manganese nickel composite oxides (LiₓMn_{2-y}Ni_{y}O₄), lithium manganese cobalt composite oxides (LiₓMn_{y}Co_{1-y}O₂), lithium iron phosphate (LiₓFePO₄). Herein x and y are 0<x≦1 and 0<y≦1, respectively.

Further, lithium nickel cobalt manganese composite oxide represented by the formula: LiₐNi_{b}Co_{c}Mn_{d}O₂ (herein, mole percentages “a”, “b”, “c” and “d” are 0≦a≦1.1, 0.1≦b≦0.5, 0≦c≦0.9 and 0.1≦d≦0.5, respectively) can be also used as the active material.

The binder can be used, for example, as polytetrafluoroethylene (PTFE), poly(vinylidene fluoride) (PVdF), modified PVdF wherein the hydrogen atom and/or fluorine atom of PVdF is substituted by another kind of substituent group, vinylidene fluoride/propylene hexafluoride copolymer, poly(vinylidene fluoride)/tetrafluoroethylene/propylene hexafluoride terpolymer.

An organic solvent to be used for the dispersion of the binder is, for example, N-methyl-2-pyrrolidone (NMP), dimethyl formamide (DMF).

The current collector can be fabricated by making use of aluminum foil, aluminum alloy foil, stainless steel foil and titanium foil, each having a thickness of 8 to 25 μm for instance.

Preferably, the current collector is formed of aluminum foil or aluminum alloy foil, each having, just like that of current collector of the negative electrode, an average crystal grain diameter of not more than 50 μm, more preferably not more than 30 μm, most preferably not more than 5 μm. The aluminum foil or aluminum alloy foil having an average crystal grain diameter of not more than 50 μm is effective in greatly increasing the mechanical strength of the current collector. Because of this, the positive electrode can be increased in density by making use of high pressing pressure, thereby making it possible to increase the capacity of battery.

The aluminum foil or aluminum alloy foil having an average crystal grain diameter of not more than 50 μm is complicatedly influenced by various factors such as the material composition thereof, impurities, working conditions, heating conditions such as thermal hysteresis and annealing, so that the aforementioned average crystal grain diameter can be regulated through a combination of these factors during the manufacturing process thereof.

The thickness of the aluminum foil or aluminum alloy foil is preferably not more than 20 μm, more preferably not more than 15 μm. Further, it is desirable that the aluminum foil has a purity of 99% or more. The aluminum alloys may preferably be selected from alloys containing magnesium, zinc, silicon. If aluminum alloys contains a transition metal such as iron, copper, nickel, chromium, the quantity thereof is preferably not more than 1% by weight.

The mixing ratio among the active material, the conductive agent and the binder is preferable to confine the active material of 80 to 95% by weight, the conductive agent of 3 to 20% by weight and the binder of 1.5 to 7 by weight.

3) Separator

The separator is formed of a porous separator. The porous separator can be used, for example, as a porous film formed of polyethylene, polypropylene, cellulose or polyvinylidene fluoride (PVdF); and unwoven fabrics formed of synthetic resin. Among them, a porous film formed of polyethylene and/or polypropylene is preferable, since it is easy to provide the porous film with a shutdown function, i.e., a function to greatly attenuate the charge/discharge current that can be achieved by the closure of fine pores of the film at the cell temperature being excessively increased, thus enhancing the safety of the secondary battery.

4) Non-aqueous electrolyte

The non-aqueous electrolyte can be used an organic electrolyte comprising an organic solvent in which at least one lithium salt selected from the group consisting of LiBF₄, LiPF₆, LiAsF₆, LiClO₄, LiCF₃SO₃, Li(CF₃SO₂)₂N, Li(C₂F₅SO₂)₂N, Li(CF₃SO₂)₃C and LiB[(OCO)₂]₂ is dissolved at a concentration of 0.5 to 2 mole/L.

Examples of the organic solvent include cyclic carbonates such as propylene carbonate (PC) and ethylene carbonate (EC); linear carbonates such as diethylene carbonate (DEC), dimethylene carbonate (DMC) and methylethyl carbonate (MEC); linear ethers such as dimethoxy ethane (DME); cyclic ethers such as tetrahydrofuran (THF) and dioxorane (DOX); γ-butyrolactone (GBL); acetonitrile (AN); sulforane (SL). These solvents can be employed singly or in combination of two or more kinds.

The non-aqueous electrolyte may be selected from cold melting salts (ionic melt) containing lithium ion. This ionic melt consists of the lithium ion, an organic cation and an organic anion. When this cation is selected from those which are liquid at a temperature of not higher than 100° C., preferably even at a temperature of not higher than room temperature, it is possible to obtain a secondary battery of wide operating temperature.

5) Outer Case

The outer case is formed of a metallic outer case which comprises a rectangular cylindrical metal can having closed bottom and a rectangular lid attached to the opening of the metal can. In the case of the metallic outer case, it should preferably be constituted by metallic material consisting mainly of aluminum or by alloy material consisting mainly of aluminum, because these materials are light in weight and excellent in corrosion resistance. The inner wall of the outer case is desirably coated with a heat fusible resin (thermoplastic resin) in order to provide the outer case with insulating property and corrosion resistance.

Other than the metallic outer case, the outer case may be fabricated by making use of an aluminum laminate film. Preferably, the thickness of the laminate film is not more than 0.2 mm. This laminate film can be constituted, for example, by a composite film consisting of a heat fusible resin film (thermoplastic resin film) to be disposed as an innermost layer, a metal foil such as aluminum foil to be disposed as an intermediate layer and a rigid organic resin film to be disposed as an outermost layer. The heat fusible resin film can be used, for example, as polyethylene (PE) film, polypropylene (PP) film, polypropylene-polyethylene copolymer film, ionomer film, ethylene vinylacetate (EVA) film. The rigid organic resin film can be used, for example, as polyethylene terephthalate (PET) film, nylon film.

6) Positive Electrode Terminal and Negative Electrode Terminal

The positive terminal may be made of aluminum, titanium, aluminum alloy, titanium alloy, stainless steel. The negative electrode terminal may be made of nickel, copper, nickel alloy, copper alloy, etc. In a case where the electric potential of negative electrode compared with a reference electric potential of lithium-metal is nobler than 1V as in the case where lithium titanium oxide is employed as an active material for the negative electrode, aluminum foil or aluminum alloy foil can be used for fabricating the negative electrode terminal. In this case, the use of aluminum foil or aluminum alloy foil for fabricating not only the positive electrode terminal but also the negative electrode terminal would be preferable, since a battery which is light in weight and low in electric resistance can be obtained by making use of these foils.

The present invention will be further explained in detail with reference to specific examples which are not intended to limit the scope of the present invention.

### EXAMPLE 1

### Manufacture of Positive Electrode

First of all, 85 wt % of lithium cobalt oxide (LiCoO₂) as an active material for the positive electrode, 10 wt % of acetylene black employed as a conductive agent, and 5 wt % of poly(vinylidene fluoride) as a binder were added to and mixed with N-methylpyrrolidone (NMP) to prepare a slurry. This slurry was then coated on the opposite surfaces of a current collector made of aluminum foil (purity: 99.99%) having a thickness of 15 μm and an average crystal grain diameter of 50 μm and then dried and pressed to manufacture a positive electrode.

<Manufacture of Negative Electrode>

First of all, 80 wt % of lithium titanate (Li₄Ti₅O₁₂) as an active material for the negative electrode, 10 wt % of acetylene black employed as a conductive agent, and 10 wt % of poly(vinylidene fluoride) as a binder were added to and mixed with N-methylpyrrolidone (NMP) to prepare a slurry. This slurry was then coated on the opposite surfaces of a current collector made of aluminum foil (purity: 99.99°) having a thickness of 15 μm and an average crystal grain diameter of 50 μm and then dried and pressed to manufacture a negative electrode.

<Preparation of Liquid Non-Aqueous Electrolyte>

2M of LiBF₄ was mixed with a mixed solvent mixed with EC, PC and GBL by the volume ratio of 1:1:4 to prepare a non-aqueous electrolyte.

<Assembling of Battery>

A container formed of a rectangular cylindrical metal can having a closed bottom and made of an aluminum sheet 0.3 mm in thickness, and a rectangular lid made of an aluminum sheet was prepared. The rectangular lid was provided with a positive electrode terminal which was piercingly attached thereto and with a negative electrode which was piercingly attached thereto by way of a hermetic seal using a glass material.

A separator formed of a polyethylene porous film was impregnated with a non-aqueous electrolyte and then the positive electrode was covered with this separator. Thereafter, the negative electrode was superimposed on the positive electrode with the separator being interposed therebetween and the resultant laminate was spirally wound to manufacture a spirally wound electrode group with a lead tab being extended from the positive electrode and also from the negative electrode. This electrode group was then press-molded to obtain a flattened electrode group. The positive electrode lead tab of the flattened electrode group was connected with one end of the positive electrode terminal of the lid and the negative electrode lead tab thereof was connected with one end of the negative electrode terminal of the lid. The electrode group and the lid were concurrently introduced into the interior of the metal can through the opening of the metal can. Then, the lid was welded to the opening of the metal can. As a result of these steps, it was possible to manufacture a flat and rectangular type non-aqueous electrolyte battery having a structure as shown in FIG. 2 and a dimension of: 3.0 mm in thickness, 35 mm in width and 62 mm in height.

Five flat and rectangular type non-aqueous electrolyte batteries, each obtained as described above, were laminated as shown in FIG. 1 and, at the same time, a couple of ethylenepropylene rubber spacers were interposed in parallel between the batteries to manufacture a combination battery. The couple of spacers were also disposed on both sides of the top battery of the combination battery as well as on both sides of the bottom battery thereof. These non-aqueous electrolyte batteries were electrically connected in series. Then, a hollow body (bag) was inserted into a space encircled by a couple of the spacers and by a couple of batteries. This hollow body (bag) was inserted also into a space created by a couple of the spacers on the top surface and bottom surface of the combination battery. These hollow bodies were respectively fabricated from a polypropylene film having a thickness of 200 μm and a melting point of 110° C. Then, the cooling medium supply side of the cooling pipe was connected, via the inlet side joint tubes (made of resin), with one of the sidewalls of each of hollow bodies which was located opposite to the other sidewall located close to the projected terminals of the positive and negative electrodes of the flat non-aqueous electrolyte battery. Further, the cooling medium outlet side of the cooling pipe was connected, via the outlet side joint tubes (made of resin), with the other sidewall of each of hollow bodies. The aperture diameter of the inlet side joint tubes was 1.2 times as large as the aperture diameter of the outlet side joint tube, thereby enabling the cooling medium to uniformly flow through the interior of each of the hollow bodies and, at the same time, causing a differential pressure between the inlet of the hollow body and the outlet thereof.

Then, the combination battery was clamped by making use of a resin band. Thereafter, the combination battery and the cooling medium supply portion and cooling medium discharge portion of the cooling pipe were placed in the aluminum packing case. Then, a radiator and a pump were connected with an intermediate region of the cooling pipe which was exposed outside the packing case. As for the cooling medium, a liquid fire extinguishing agent comprising a mixture of liquid cellulose and ethylene glycol, which was available in the market. In order to measure the surface temperature of each of the flat and rectangular type non-aqueous electrolyte batteries, a thermocouple was positioned at a central portion of each of these batteries and inside the packing case. In order to perform a test wherein an internal short circuit was assumed to take place, a bypass circuit wherein a short circuit could be externally created was installed in one of the batteries which were located at a center portion of the combination battery.

### COMPARATIVE EXAMPLE 1

In the same manner as in the case of Example 1, five flat and rectangular type non-aqueous electrolyte batteries were laminated and, at the same time, a double-coated tape was interposed between the batteries to adhere these batteries, thus manufacturing a combination battery. These five flat and rectangular type non-aqueous electrolyte batteries were electrically connected in series. Then, the combination battery was placed in the aluminum packing case. This packing case was designed such that the cooling of the combination battery was conducted externally by making use of a fan. In order to measure the surface temperature of each of the flat non-aqueous electrolyte batteries, a thermocouple was positioned at a central portion of each of these batteries and inside the packing case. In order to perform a test wherein an internal short circuit was assumed to take place, a bypass circuit wherein a short circuit could be externally created was installed in one of the batteries which were located at a center portion of the combination battery.

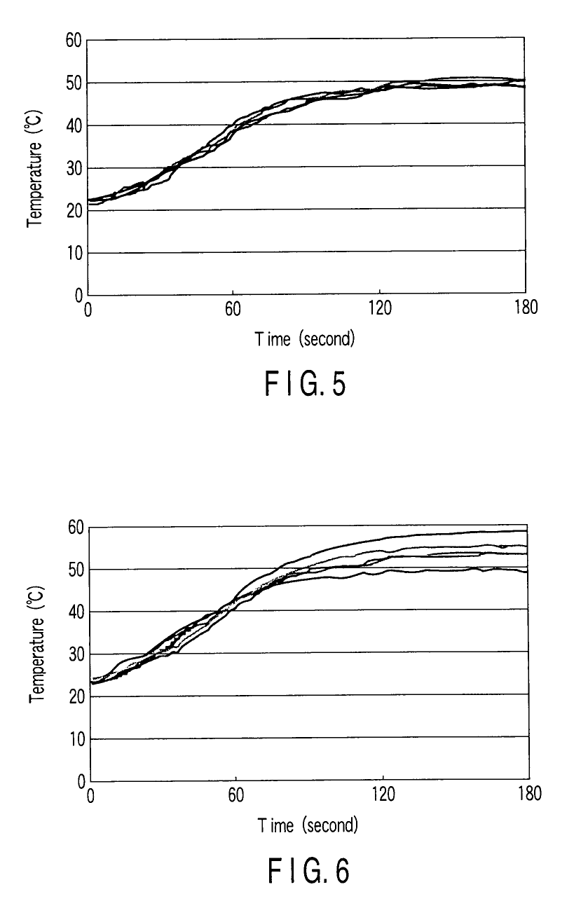

By making use of the battery pack obtained in Example 1, the changes in temperature of five flat and rectangular type non-aqueous electrolyte batteries were investigated wherein continuous discharging of the combination battery was performed at 20 C (60 A) while circulating a cooling medium through a route including the inlet side joint tubes, the hollow bodies, the outlet side joint tubes and the cooling pipe. The results obtained are shown in FIG. 5. Further, by making use of the battery pack obtained in Comparative Example 1, the changes in temperature of five flat and rectangular type non-aqueous electrolyte batteries were investigated wherein continuous discharging of the combination battery was performed at 20 C (60 A). The results obtained are shown in FIG. 6.

As apparent from the results shown in FIG. 5, in the case of the battery pack of Example 1, the rise in cell temperature which was caused to occur on the occasion of discharging was almost the same in temperature distribution irrespective of the location of battery in the lamination of combination battery. The reason for this may be attributed to the heat-equalizing effects of the cooling medium passing through the hollow bodies interposed between the batteries.

Whereas, the battery pack of Comparative Example 1 was confirmed that non-uniformity in temperature distribution was taken place among the batteries at discharging thereof as shown in FIG. 6. The reason for this may be attributed to the fact that since the cooling of batteries was performed externally from the outside of the packing case by making use of the fan, prominent rise in temperature was caused to occur especially at the batteries which were located at the central portion in the lamination of the combination battery where cooling effects could not be sufficiently obtained, thereby producing a difference in temperature between the central batteries and the outside batteries where cooling effects could be easily obtained.

Next, by making use of the battery packs obtained in Example 1 and Comparative Example 1, the maximum temperature of batteries, the occurrence of fuming of batteries and the temperature rise of adjacent batteries at the moment when the short-circuiting of batteries located at the central region of combination battery was externally caused. The results are shown in the following Table 1.

TABLE 1

| | Maximum | | |
|---|---|---|---|
| | temperature | Generation | Rise in temperature of |
| | of battery | of fuming | neighboring batteries |
| Example 1 | 121° C. | None | +5° C. |
| Comparative | 156° C. | Yes | +32° C. |
| Example 1 | | | |

As apparent from the results shown in Table 1, in the case of the battery of Example 1, the development of heat up to 121° C. at maximum immediately after the short-circuiting of the battery was observed. At the same time, it was also recognized that due to the melting and damage of the hollow body made of polypropylene film having a melting point of 110° C., the cooling medium was caused to flow into the interior of the packing case, thus filling the packing case with the cooling medium. On this occasion, although the swelling of the outer case of each of a flat and rectangular type non-aqueous electrolyte batteries was recognized, it was impossible to recognize the occurrence of fumes or ignition from the battery pack and also the heat build-up in the adjacent batteries was not recognized.

Whereas, in the case of the battery of Comparative Example 1, the development of heat up to 156° C. at maximum was observed immediately after the short-circuiting of the battery. Furthermore, the rise in temperature of the adjacent batteries by a temperature of 32° C. at maximum was recognized. Additionally, the lid of the outer case of the flat and rectangular type non-aqueous electrolyte battery was caused to open and the fumes due to the evaporation of the non-aqueous electrolyte from the battery pack were also recognized, thus indicating the possibilities of causing the ignition of batteries.

Although a combination battery which was equipped with five flat and rectangular type non-aqueous electrolyte batteries each electrically connected in series was used in this test, the number of flat and rectangular type non-aqueous electrolyte batteries required to be electrically connected in series would become 100 to 200 if the combination battery is to be applied to a hybrid electric vehicle. Therefore, in that case, the influence by the heat build-up in the interior of battery pack as well as by the fuming of the non-aqueous electrolyte would become enormous. In this respect, the battery pack of the present invention was confirmed as being capable of improving the safety thereof.

Finally, the vibration test of the battery pack was performed. Namely, the battery packs of Example 1 and Comparative Example 1 were mounted on a vibrating machine and moved sweepingly and at random under the conditions of 5-200 Hz, thereby vibrating the combination batteries placed in the packing cases in the three-dimensional directions (x, y, z) for 6 hours in total. After this vibration test, the battery packs were respectively disassembled to observe the surface of outer case of the flat and rectangular type non-aqueous electrolyte battery and to investigate the existence of flaws, cracking and the leakage of electrolyte. The results obtained are shown in the following Table 2.

TABLE 2

Vibration resistance

| | | Generation of |
|---|---|---|
| | Flaw or deformation | abnormality in |
| | on battery surface | battery |
| Example 1 | Slightly depressed | None |
| Comparative | Trace of | Cracks in welded |
| Example 1 | rubbing/deformation | portion of |
| | in outer case | electrodes |

As apparent from the results shown in Table 2, in the case of the battery of Example 1, although it was possible to recognize slightly depressed portions on surface portions of the outer case which were contacted with the spacers, it was impossible to recognize any flaw or cracking of the outer case and any deformation of the outer case was not recognized. Further, when the battery was disassembled after the vibration test, it was impossible to recognize any cracking or rupture at the welded portion provided between the electrode lead tabs and the electrode terminals attached to the cap of outer case, thus indicating the normal condition of the battery.

Therefore, it is possible to provide a battery pack which is highly resistive to vibration since the hollow body for passing a cooling medium acts as a cushioning material against the battery.

Whereas, in the case of the battery pack of Comparative Example 1, due to the rubbing between the batteries, a trace of rubbing was recognized on the outer case and also the deformation of the outer case was recognized. Further, when the battery was disassembled after the vibration test, a cracked portion was recognized at the welded portion provided between the electrode lead tabs and the electrode terminals attached to the lid of outer case. When contact failure results from this cracked portion, it would give rise to the possibilities of abnormal heat build-up of the battery.

As explained above, in the case of the battery pack of Example 1 wherein a plurality of lithium ion secondary batteries each accommodated in a flat and rectangular type outer case were electrically connected in series, it is possible to provide a battery pack which is excellent in temperature equalization and in safety and highly resistive to vibration.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A battery pack comprising:
a packing case;
a combination battery housed in the packing case and having a plurality of flat and rectangular type secondary batteries which are laminated each other;
a hollow body interposed at least between the flat and rectangular type secondary batteries in the combination battery and made of a thermoplastic resin film having a melting point of 110 to 200° C.; and
a cooling medium passed through the hollow body and comprising an nonflammable insulating solvent.

2. The battery pack according to claim 1, wherein the thermoplastic resin is olefin-based heat fusible resin, ester-based heat fusible resin or urethane-based heat fusible resin.

3. The battery pack according to claim 1, wherein the thermoplastic resin film has a thickness of 100 to 300 μm.

4. The battery pack according to claim 1, wherein the nonflammable insulating solvent is selected from the group consisting of diisopropyl naphthalene, 1-phenyl-1-(3,4-dimethylphenyl)ethane, liquid cellulose, ethylene glycol and carbon tetrachloride.

5. The battery pack according to claim 1, wherein the hollow body is further disposed on at least one of the top and bottom surfaces of the lamination direction of the secondary batteries in the combination battery.

6. The battery pack according to claim 1, which further comprises spacers made of an insulating material, the spacers being respectively disposed to contact with at least opposite sidewalls of the hollow body.

7. The battery pack according to claim 1, which further comprises an inlet side joint tube which is communicated with the hollow body for introducing the cooling medium into the hollow body; and an outlet side joint tube which is communicated with the hollow body for discharging the cooling medium from the hollow body; wherein the inlet side joint tube has an aperture diameter which is larger than that of the outlet side joint tube.

8. The battery pack according to claim 7, wherein the inlet side joint tube has an aperture diameter which is 1.1 to 2.0 times as large as that of the outlet side joint tube.

9. The battery pack according to claim 1, which further comprises an inlet side joint tube which is communicated with the hollow body for introducing the cooling medium into the hollow body; an outlet side joint tube which is communicated with the hollow body for discharging the cooling medium from the hollow body; a cooling pipe communicated, through one end thereof, with the inlet side joint tube and also communicated, through the other end thereof, with the outlet side joint tube; and a radiator and a pump both successively provided on an intermediate portion of the cooling pipe, the radiator being positioned closer to the outlet side joint tube than the pump.

10. The battery pack according to claim 1, wherein the flat and rectangular type secondary battery is a non-aqueous lithium ion secondary battery comprising a negative electrode, a positive electrode and a separator.

11. The battery pack according to claim 10, wherein the negative electrode comprises a current collector, and an active material-containing layer containing lithium titanate oxide and formed on one or both surfaces of the current collector.

12. The battery pack according to claim 11, wherein the current collector is made of aluminum having an average crystal grain diameter of not more than 50 μm, or formed of aluminum alloy having an average crystal grain diameter of not more than 50 μm.
